(19) United States
(12) Patent Application Publication
(10) Pub. No.: US 2017/0369174 A1
(43) Pub. Date: Dec. 28, 2017

(54) PROPULSION SYSTEM FOR AIRCRAFT

(71) Applicant: SAFRAN AERO BOOSTERS S.A., Herstal (Milmort) (BE)

(72) Inventor: Mathieu Deladriere, Herstal (BE)

(73) Assignee: SAFRAN AERO BOOSTERS S.A., Herstal (Milmort) (BE)

(21) Appl. No.: 15/635,085

(22) Filed: Jun. 27, 2017

(30) Foreign Application Priority Data
Jun. 28, 2016 (BE) 2016/5486

(51) Int. Cl. B64D 15/10; F02C 7/264; F02C 3/04

(52) U.S. Cl. CPC B64D 15/10; F02C 7/264; F02C 3/04; F05D 2220/323

(57) ABSTRACT

An aircraft comprising a turbine engine, an atomizer, a reservoir, a conduit connecting the reservoir to the atomizer, and a unit for controlling the flow of liquid in the atomizer. The turbine engine, the atomizer, the reservoir, the conduit and the control unit are fixed to the aircraft. This allows cleaning in flight of at least some parts of the turbine engine.

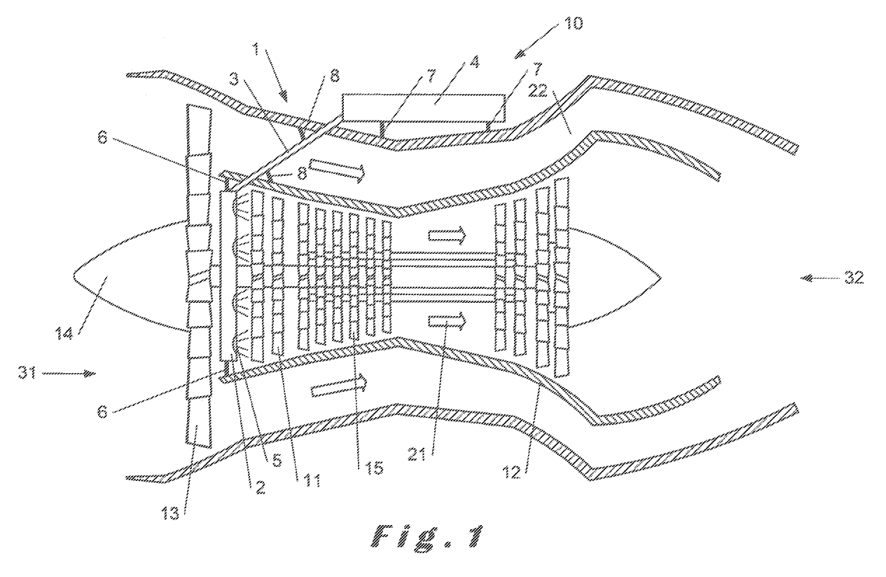

### FIELD OF THE DISCLOSURE

According to a first aspect, embodiments of the present disclosure relate to an aircraft comprising a cleaning system for at least one of its turbine engines. According to a second aspect, embodiments of the present disclosure relate to a method for cleaning aircraft turbine engines. According to a third aspect, embodiments of the present disclosure relate to a method for de-icing turbine engines.

### BACKGROUND

Aircraft turbine engines get fouled up because of atmospheric pollution and combustion. In particular, atmospheric pollution and combustion contaminate the surfaces of the primary duct causing an increase in the EGT (exhaust gas temperature) for achieving a given thrust, or conversely a reduced thrust for a given EGT.

Document EP 2966265 A1 discloses a cleaning system for an aircraft turbine engine. One problem with this system is that the use thereof requires the aircraft to be at rest.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

According to a first aspect, one of the aims of the disclosed technology is to provide an aircraft provided with a propulsion system including a turbine engine and affording precise and controlled cleaning thereof, in particular in flight. To this end, the disclosed technology proposes an aircraft comprising a propulsion system that comprises:

a dual-flow turbine engine comprising: an inlet for receiving air, an outlet for expelling air, an annular separator for obtaining, between the inlet and the outlet, a first passage for a primary airflow and a second passage external and concentric to the first passage for a secondary airflow, and a low-pressure compressor situated in the first passage in order to compress the primary airflow;

an aqueous-liquid atomizer comprising a first atomization outlet situated between the turbine-engine inlet and the low-pressure compressor in the first passage in order to inject an aqueous liquid therein;

first fixing means fixing the atomizer inside the turbine engine;

a reservoir for containing the aqueous liquid, housed and fixed in the aircraft;

second fixing means fixing the reservoir in the aircraft;

a conduit fluidically connecting the reservoir to the atomizer; and

a control unit configured to control a flow of aqueous liquid atomized by the atomizer.

The propulsion system for an aircraft according to embodiments of the present disclosure comprise a system for cleaning an aircraft turbine engine. The aqueous liquid present in the reservoir housed and fixed in the aircraft passes through the conduit and is then injected into the low-pressure compressor by the atomizer. There, the aqueous liquid cleans the low-pressure compressor. It may also optionally clean elements of the turbine engine downstream of the low-pressure compressor in the first passage, which corresponds to the primary flow.

In addition, the fact that the reservoir, the conduit and the atomizer are fixed to the aircraft enables the cleaning to be done during taxiing periods of the aircraft and in flight. The cleaning therefore does not require keeping the aircraft immobilized.

The propulsion system according to embodiments of the present disclosure affords a particularly precise cleaning of the primary-flow surfaces, that is to say of the surfaces of all the elements of the turbine engine present in the primary flow, since the first atomization outlet injects aqueous liquid into the first passage. The cleaning therefore also consumes a particularly small amount of aqueous liquid.

Furthermore, the cleaning provided by the propulsion system according to embodiments of the present disclosure is particularly well controlled by the control unit. The time of cleaning, the duration thereof and the pressure of the aqueous liquid can thus be controlled.

The propulsion system described above may be referred to as the “first propulsion system”.

The reservoir in some embodiments comprises a reserve of aqueous liquid sufficient for a plurality of cleanings. The reservoir may comprise between 50 and 10,000 liters of aqueous liquid, and in some embodiments between 100 and 1000 liters of aqueous liquid. The reservoir can be filled regularly, at suitable times with respect to the aircraft flight plan. Next, the reservoir is emptied little by little along with the cleanings, on the ground (for example during taxiing) or in flight, when cleaning is necessary. One cleaning may for example consume between 60 and 80 liters of aqueous liquid.

The first atomization outlet in some embodiments comprises holes directed towards the outlet. In some embodiments, the holes have a diameter of between 5 and 10 mm. This makes it possible to eject the aqueous liquid under pressure. It may make it possible to eject the aqueous liquid in the form of droplets. It may comprise a spray and/or injection nozzles in some embodiments.

The aqueous liquid in some embodiments is an aqueous solution. The aqueous liquid may for example be water, cleaning liquid or an air/water mixture, may comprise a large quantity of dissolved air or air bubbles (for example at least 10% air and up to at least 30% or greater), and may comprise a de-icing liquid (for example for improving its de-icing function). In some embodiments, the aqueous liquid does not comprise any oil or organic lubricant.

In the context of the present document, “fixing means,” such as first fixing means, second fixing means, third fixing means, etc., include long-term fixing means provided for fixing together elements in a fixed relative position for weeks, months or years. In some embodiments, fixing means includes but is not limited to fasteners, such as for example, screws, bolts, nuts, rivets, welds, heat bonding, adhesive, and other mechanical or chemical techniques for fastening presently known or future developed, and equivalents thereof.

The conduit in some embodiments is fixed, by fourth fixing means, to at least one of: the aircraft, the reservoir and the annular separator.

The atomizer in some embodiments is fixed to the annular separator by the first fixing means.

The atomizer in some embodiments comprises a pump. In one embodiment, the propulsion system comprises a pump acting on the aqueous liquid of the reservoir and/or of the conduit. In one embodiment, the control unit controls the pump.

The annular separator is sometimes referred to as a “splitter”.

In one embodiment, the reservoir is fixed in or to the turbine engine by fastening techniques, including the use of a second fixing means.

In one embodiment, the reservoir is connected fluidically to an inlet arranged so as to allow an introduction of aqueous liquid from the outside of the aircraft. This allows the reservoir to be easily and copiously supplied with aqueous liquid when the aircraft is at rest. Next, when the aircraft is taxiing or in flight, the reservoir supplies the atomizer in order to clean the turbine engine.

The connection between the reservoir and this inlet in some embodiments is made by a direct pipe. There is therefore no pump for example between the inlet and the reservoir. The direct pipe in some embodiments is less than one meter long, and in some embodiments less than 50 cm long.

In one embodiment, the turbine engine comprises a front cone comprising the reservoir.

In one embodiment, the reservoir is fixed in or to the low-pressure compressor by fastening techniques that may include the second fixing means.

In one embodiment, the annular separator comprises the reservoir. The reservoir may be fixed to the annular separator by the second fixing means.

In one embodiment, the reservoir is fixed to or in a nacelle of the turbine engine by the second fixing means.

In one embodiment, the turbine engine comprises a fan and the first atomization outlet is situated between the latter and the low-pressure compressor. This makes it possible for the cleaning to be particular effective since the aqueous liquid is injected directly in the vicinity of the low-pressure compressor. This avoids any reverberation of the cleaning liquid on the fan.

In one embodiment, the atomizer comprises a second atomization outlet situated between the inlet of the turbine engine and the low-pressure compressor in the second passage in order to inject the aqueous liquid therein. This makes it possible to clean the surfaces of the second passage, that is to say the secondary-flow surfaces. This also makes it possible to inject liquid into the secondary flow in order to assist propulsion.

In one embodiment, the reservoir is connected fluidically to a system for de-icing the annular separator or the low-pressure compressor.

In one embodiment, the reservoir is connected fluidically to a recovery system for recovering aqueous liquid between the low-pressure compressor and the outlet. This makes it possible to reduce the quantity of aqueous liquid and therefore the weight thereof.

In one embodiment, the reservoir is arranged so as to recover condensation water during the flight of the aircraft.

In one embodiment, the propulsion system comprises a heater or other heating means for heating the aqueous liquid in the turbine engine. This makes the cleaning more effective.

In one embodiment, the heating means comprises a water circuit for recovering heat generated by the turbine engine. Other heating means may include electrical resistive heating elements, heat exchangers that obtain heat transfer from other systems of the aircraft, etc.

In one embodiment, the propulsion system for an aircraft further comprises at least a second turbine engine and a second aqueous-liquid atomizer situated in the second turbine engine and fluidically connected to the reservoir.

The second turbine engine in some embodiments is similar to the first.

Furthermore, the elements of the propulsion system fixed to the second turbine engine can be fixed thereto in the same way as the similar elements are fixed to the first turbine engine.

The propulsion system in some embodiments comprises only one control unit making it possible to control a flow of aqueous liquid in each of the atomizers.

In one embodiment, the aircraft comprises another propulsion system that comprises:

another dual-flow turbine engine comprising:

another inlet for receiving air,

another outlet for expelling air,

another annular separator for obtaining, between the other inlet and the other outlet, another first passage for another primary airflow and another second passage external and concentric to the other first passage for another secondary airflow, and

another low-pressure compressor situated in the other first passage in order to compress the other primary airflow;

another aqueous-liquid atomizer comprising another first atomization outlet situated between the other turbine-engine inlet and the other low-pressure compressor in the other first passage in order to inject an aqueous liquid therein;

other first fixing means fixing the other atomizer inside the other turbine engine;

another reservoir for containing the aqueous liquid, housed and fixed in the aircraft;

other second fixing means fixing the reservoir in the aircraft; and

another conduit fluidically connecting the other reservoir to the other atomizer.

In other words, the other propulsion system, which may be referred to as the second propulsion system, is similar to the first propulsion system except for the control unit. This is because the control unit of the first propulsion system may also be arranged so as to control a flow of aqueous fluid atomized by the other atomizer. It is also possible for the second propulsion system to comprise a second control unit arranged so as to control a flow of aqueous fluid atomized by the other atomizer, which may be completely or partially independent of the control unit of the first propulsion system.

The use of a second propulsion system having its own reservoir, referred to sometimes as the “other reservoir”, makes it possible for each of the reservoirs to be close to the turbine engine for which it stores aqueous liquid. This therefore reduces the length of the liquid-conveyance pipes.

In one embodiment, the control unit is fixed to the aircraft by third fixing means.

In some embodiments, the control unit comprises a control situated in the cockpit of the aircraft arranged so as to generate atomization by the atomizer. This makes it possible to actuate the cleaning by atomizer from the cockpit.

According to a second aspect, embodiments of the present disclosure propose a method for cleaning aircraft turbine engines comprising the steps of:

providing an aircraft according to embodiments of the present disclosure,

providing an aqueous liquid in the reservoir,

igniting the turbine engine, and

injecting aqueous liquid into the turbine engine by the atomizer.

This makes it possible to quickly and effectively clean the turbine engine and in particular its low-pressure compressor.

The injection of aqueous liquid is actuated via the control unit, for example from the cockpit.

Embodiments of the present disclosure also relate to a use of this cleaning method for a rolling period of the aircraft.

The rolling period, sometimes referred to as taxiing, is the phase preceding takeoff and following takeoff during which the aircraft moves on the ground using its turbine engine. Cleaning the turbine engine during this period saves a great deal of time compared with cleaning when the aircraft is at rest.

According to a third aspect, embodiments of the present disclosure propose a method for de-icing an aircraft turbine engine comprising the steps of:

providing an aircraft according to embodiments of the present disclosure,

providing a de-icing liquid in the reservoir,

igniting the turbine engine, and

injecting de-icing liquid into the turbine engine by the atomizer.

A “de-icing liquid” may be any liquid able to assist the de-icing of the components of the turbine engine. The injection of de-icing liquid is actuated via the control unit, for example from the cockpit.

The advantages mentioned for the device apply mutatis mutandis to the methods.

### DESCRIPTION OF THE DRAWINGS

The foregoing aspects and many of the attendant advantages of the claimed subject matter will become more readily appreciated as the same become better understood by reference to the following detailed description, when taken in conjunction with the accompanying drawings, wherein the FIGURE is a cross sectional view illustrating elements of a propulsion system for an aircraft in one embodiment of the disclosure.

### DETAILED DESCRIPTION

Embodiments of the present disclosure are described on the basis of specific examples and with reference to the drawings, but such embodiments should not be limited thereby. The drawings described are only schematic and are not limiting.

In the context of the present document, the terms “first” and “second” are used only to differentiate the different elements and do not imply an order between these elements. In the drawings, identical or similar elements may have the same reference signs.

The FIGURE is a cross sectional view illustrating elements of a propulsion system for an aircraft in one embodiment of the disclosure. The propulsion system comprises a turbine engine 10 that includes in particular: an air inlet 31, a front cone 14, a fan 13, an annular separator 12, a low-pressure compressor 11, a high-pressure compressor 15 and an air outlet 32. The annular separator 12 separates a first passage 21 for a primary airflow from a second passage 22 for a secondary airflow, the second passage 22 being concentric with, and external to, the first passage. The annular separator 12 is in some embodiments annular.

The propulsion system further comprises an atomizer 2 that is housed in the aircraft and fixed to the aircraft by a first fastener or first fixing means 6, a reservoir 4 that is housed in the aircraft and fixed to the aircraft by a second fastener or second fixing means 7, and a conduit 3 that is housed in the aircraft and fixed to the aircraft by a fourth fastener or fourth fixing means 8.

The conduit 3 allows an aqueous liquid to pass from the reservoir 4 to the atomizer 2.

The propulsion system further comprises a control unit, such as a microprocessor based or field-programmable gate array (FPGA) based controller, which can be fixed to the aircraft by one or more fasteners or by a third fastener or third fixing means, and making it possible to control the flow of aqueous liquid atomized by the atomizer. In some embodiments, the control unit, or any control unit described herein, may include logic carry out by a processor, a central processing unit (CPU), a digital signal processor (DSP), an application-specific integrated circuit (ASIC), a field-programmable gate array (FPGA), or the like, or any combinations thereof, and can include discrete digital or analog circuit elements or electronics, or combinations thereof.

The atomizer 2 comprises a first atomization outlet 5 fluidically connected to the reservoir 4 by the conduit 3 and oriented so as to send the aqueous liquid into the low-pressure compressor 11. The first atomization outlet 5 makes it possible to inject aqueous liquid into the first passage 21.

The atomizer 2 is fixed in the aircraft by second fixing means 6. The atomizer 2 may for example be fixed to the annular separator 12. The atomizer 2 may comprise an element including the first atomization outlet 5 having a roughly circular or roughly star shape. The atomizer 2 may comprise a second atomization outlet situated between the inlet 31 and the low-pressure compressor 11, in the second passage 22, to inject the aqueous liquid into the second passage 22.

The reservoir 4, the conduit 3 and the atomizer 2 are included in a cleaning assembly 1 according to embodiments of the present disclosure. This cleaning assembly 1 comprises the control unit in some embodiments.

The turbine engine 10 is housed in a nacelle of the aircraft.

In one embodiment, the aqueous liquid makes it possible to de-ice the elements with which it comes into contact. It can comprise a de-icing liquid in some embodiments.

In one embodiment, the reservoir 4 is at least partially supplied by a system for de-icing the annular separator 12 or a system for de-icing the low-pressure compressor 11. The coupling between the de-icing system and the reservoir 4 may for example be done by a three-way valve and/or by a venturi system.

In one embodiment, the reservoir 4 is at least partially supplied by a liquid-recovery system arranged to recover aqueous liquid downstream of the low-pressure compressor 11. This liquid-recovery system may be between the low-pressure compressor 11 and the high-pressure compressor 15, or downstream of the high-pressure compressor 15. This liquid-recovery system may comprise a VBV (variable bleed vane) system, for example disposed between the low-pressure compressor 11 and the high-pressure compressor 15. This liquid-recovery system may comprise a condensation system. In one embodiment, the aqueous liquid circulates in a closed circuit by this liquid-recovery system.

In one embodiment, the aqueous liquid is heated by the turbine engine 10, for example via a water system making it possible to recover heat generated by the turbine engine 10. This makes it possible to improve cleaning and to cool the turbine engine 10. In particular, the aqueous liquid may be heated by an injected-air system or by a circulation circuit around the turbine engine 10. The aqueous liquid may be also heated by an electric heater or other heating techniques currently known or developed in the future.

The turbine engine 10 may for example be disposed on a fuselage of an aircraft, in a fuselage of an aircraft, on a wing of an aircraft, under a wing of an aircraft or in the wing of an aircraft.

In one embodiment, the reservoir 4 is provided with a drainage system, for example a drainage system similar to the one in fuel tanks making it possible to empty the reservoir 4 through a reservoir outlet other than the atomizer 2. This drainage system may for example make it possible to reduce the mass of the aircraft in flight.

In one embodiment, a plurality of turbine engines of an aircraft are provided with an aqueous-liquid atomizer fluidically connected to the same reservoir 4. In some embodiments, each aqueous-liquid atomizer is arranged as described above and connected to the reservoir 4 by its own conduit, and each conduit is arranged as described above. This may be the case in a four-engined aircraft for example.

In other words, embodiments of the present disclosure relate to a propulsion system for an aircraft. The propulsion system comprises a turbine engine, an atomizer, a reservoir, a conduit connecting the reservoir to the atomizer, and a unit for controlling the flow of liquid in the atomizer. The turbine engine, the atomizer, the reservoir, the conduit and the control unit are fixed to the aircraft.

The propulsion system may allow the cleaning of at least some parts of the turbine engine.

Embodiments of the present disclosure have been described in relation to specific embodiments, which have a purely illustrative value and must not be considered to be limitative. In general terms, embodiments of the present disclosure are not limited to the examples illustrated and/or described above. The use of the verbs “comprise”, “include”, “have”, or any other variant, as well as conjugations thereof, may in no way exclude the presence of elements other than those mentioned. The use of the indefinite article “a” or “an” or of the definite article “the”, to introduce an element, does not exclude the presence of a plurality of these elements. Any reference numbers in the claims do not limit the scope thereof.

While illustrative embodiments have been illustrated and described, it will be appreciated that various changes can be made therein without departing from the spirit and scope of the claimed subject matter.

The embodiments of the disclosure in which an exclusive property or privilege is claimed are defined as follows:

1. Aircraft comprising a propulsion system that comprises:
a dual-flow turbine engine comprising:
an inlet for receiving air,
an outlet for expelling air,
an annular separator for obtaining, between the inlet and the outlet, a first passage for a primary airflow and a second passage external and concentric to the first passage for a secondary airflow, and
a low-pressure compressor situated in the first passage in order to compress the primary airflow;
an aqueous-liquid atomizer comprising a first atomization outlet situated between the turbine-engine inlet and the low-pressure compressor in the first passage in order to inject an aqueous liquid therein;
first fixing means fixing the atomizer inside the turbine engine;
a reservoir for containing the aqueous liquid, housed and fixed in the aircraft;
second fixing means fixing the reservoir in the aircraft;
a conduit fluidically connecting the reservoir to the atomizer; and
a control unit configured to control a flow of aqueous liquid atomized by the atomizer.

2. The aircraft according to claim 1, wherein the reservoir is fluidically connected to an inlet arranged so as to allow introduction of aqueous liquid from the outside of the aircraft.

3. The aircraft according to claim 1, wherein the reservoir is: included in the annular separator, included in a front cone of the turbine engine, fixed in the low-pressure compressor by second fixing means or fixed in a nacelle of the turbine engine by the second fixing means.

4. The aircraft according to claim 1, wherein the turbine engine comprises a fan situated between the inlet of the turbine engine and the low-pressure compressor and in that the first atomization outlet is situated between said fan and the low-pressure compressor.

5. The aircraft according to claim 1, wherein the atomizer comprises a second atomization outlet situated between the inlet of the turbine engine and the low-pressure compressor in the second passage in order to inject the aqueous liquid therein.

6. The aircraft according to claim 1, wherein the reservoir is fluidically connected to a system for de-icing the annular separator or the low-pressure compressor.

7. The aircraft according to claim 1, wherein the reservoir is fluidically connected to a recovery system in order to recover aqueous liquid between the low-pressure compressor and the outlet.

8. The aircraft according to claim 1, comprising a heating means for heating the aqueous liquid in the turbine engine.

9. The aircraft according to claim 1, wherein the heating means comprises a water circuit for recovering heat generated by the turbine engine.

10. The aircraft according to claim 1, further comprising at least a second turbine engine and a second aqueous-liquid atomizer situated in the second turbine engine and fluidically connected to the reservoir.

11. The aircraft according to claim 1, comprising another propulsion system that comprises:
another dual-flow turbine engine comprising:
another inlet for receiving air,
another outlet for expelling air,
another annular separator for obtaining, between the other inlet and the other outlet, another first passage for a primary airflow and another second passage external and concentric to the first passage for another secondary airflow, and
another low-pressure compressor situated in the other first passage in order to compress the other primary airflow;
another aqueous-liquid atomizer comprising another first atomization outlet situated between the other turbine-engine inlet and the other low-pressure compressor in the other first passage in order to inject an aqueous liquid therein;
other first fixing means fixing the other atomizer inside the other turbine engine;
another reservoir for containing the aqueous liquid, housed and fixed in the aircraft;
other second fixing means fixing the reservoir in the aircraft; and
another conduit fluidically connecting the other reservoir to the other atomizer.

12. The aircraft according to claim 1, wherein the control unit is fixed to the aircraft by third fixing means.

13. Method for cleaning an aircraft turbine engine, comprising the steps of:
providing an aircraft according to claim 1,
providing an aqueous liquid in the reservoir,
igniting the turbine engine, and
injecting aqueous liquid into the turbine engine by means of the atomizer.

14. The method according to claim 13, wherein said injecting occurs during a rolling period of the aircraft.

15. Method for de-icing an aircraft turbine engine, comprising the steps of:
providing an aircraft according to claim 1,
providing a de-icing liquid in the reservoir,
igniting the turbine engine, and
injecting de-icing liquid into the turbine engine by the atomizer.
